(19) United States
(12) Patent Application Publication
(10) Pub. No.: US 2011/0306688 A1
(43) Pub. Date: Dec. 15, 2011

(54) METHODS AND SYSTEMS FOR RECYCLING FIBROUS SUBSTRATES

(75) Inventors: Nirmal K. Agarwal, Columbia, SC (US); Preston Thomas Compton, Elgin, SC (US)

(73) Assignee: INVISTA NORTH AMERICA S.A.R.L., Wilmington, DE (US)

(21) Appl. No.: 13/054,562

(22) PCT Filed: Jul. 16, 2009
(86) PCT No.: PCT/US2009/050816

§ 371 Date: May 3, 2011

Related U.S. Application Data
(60) Provisional application No. 61/081,934, filed on Jul. 18, 2008.

(51) Int. Cl. C08J 11/06

(52) U.S. Cl. 521/48; 521/49.8; 521/40

(57) ABSTRACT

Embodiments of the present disclosure include methods of removing face fibers from a fibrous substrate, systems of removing face fibers from a fibrous substrate, and the like.

### CROSS-REFERENCE TO RELATED APPLICATION

This application claims benefit of priority from U.S. Provisional Application No. 60/081,934 filed 18 Jul. 2008.

### BACKGROUND

Carpet, particularly nylon carpet, is the floor covering of choice in many households and businesses. Unfortunately, carpet has a limited lifespan and must eventually be replaced, with the resultant used carpet waste generally being sent to a landfill or burned. In addition, during the carpet manufacturing process there is waste carpeting produced. The vast quantities of carpet waste that are generated annually are burdensome to landfill capacity and have a negative impact on the environment. Furthermore, most carpet is made with nylon as the face fiber, a material that is relatively expensive. The quantity of used carpet discarded every year amounts to a loss of billions of dollars in potentially reusable carpet components.

To reduce the impact of used carpet on the environment, and to reclaim some of the financial loss due to discarding of fibers and other useful carpet material waste, carpet recycling would appear to be a logical solution. Recycling carpet, however, is difficult because its major components are chemically and physically diverse. Thus, many methods are expensive and/or provide low yields of the recovered carpet fibers.

### SUMMARY

Embodiments of the present disclosure include methods of removing face fibers from a fibrous substrate, systems of removing face fibers from a fibrous substrate and the like. One exemplary method for removing face fibers from a fibrous substrate, among others, includes: providing a fibrous substrate, wherein the fibrous substrate includes face fibers and a backing structure; removing the face fibers from the fibrous substrate so that the face fibers and the backing structure are separated; collecting the face fibers; cleaning the face fibers (e.g., to remove contaminants such as dirt, sand, and the like); and collecting the cleaned face fibers. In an embodiment, the method includes densifying or pelletizing the resulting fiber.

One exemplary method of removing face fibers from a fibrous substrate, among others, includes: cutting a fibrous substrate into cut-portions of the fibrous substrate, wherein the fibrous substrate includes face fibers and a backing structure; cleaning the cut-portions of the fibrous substrate to remove debris; detecting for the presence of one or more of the metal objects in the cut portions of the fibrous substrate, and if a metal object is present, removing the metal objects; flattening the cut-portions of the fibrous substrate; removing the face fibers from the fibrous substrate so that the face fibers and the backing structure are separated; collecting the face fibers; cleaning the face fibers (e.g., to remove contaminants such as dirt, sand, and the like); and collecting the cleaned face fibers. In an embodiment, the method includes densifying or pelletizing the resulting fiber.

These embodiments, uses of these embodiments, and other uses, features and advantages of the present disclosure, will become more apparent to those of ordinary skill in the relevant art when the following detailed description of the preferred embodiments is read in conjunction with the appended figures.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques associated with recycling, fabrics, textiles, carpets, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DEFINITIONS

As used herein, the term “fiber” refers to filamentous material that can be used in fabric and yarn as well as textile fabrication. One or more fibers can be used to produce a fabric or yarn. The yarn can be fully drawn or textured according to methods known in the art.

As used herein, the term “fibrous substrate” includes, but is not limited to, carpets such as household carpeting, industrial carpeting, automotive carpeting, and the like. In an embodiment, a fibrous substrate includes a face fiber and a backing substrate.

As used herein, the term “carpet” may refer to a structure including a primary backing structure having a yarn tufted through the primary backing to form face fibers. The underside of the primary backing structure can include one or more layers of material (e.g., coating layer, a secondary backing, and the like) to cover the backstitches of the yarn.

As used herein, the term “primary backing” and/or the “secondary backing layer” may refer to woven or non-woven materials. The woven materials may be natural materials or synthetic materials. The woven materials can include, but are not limited to, cotton, rayon, jute, wool, polyolefins (e.g., polypropylene and polyethylene), polyester, and/or polyamide. The non-woven materials can include fibers such as, but not limited to, polypropylene, rayon, polyethylene, polyester, polyamide, and combinations thereof, blends thereof, and the like.

As used herein, the term “backing” refers to the primary backing, secondary backing, coating layer, combinations thereof, and the like.

### General Discussion

Embodiments of the present disclosure include methods of removing face fibers from a fibrous substrate, systems for removing face fibers from a fibrous substrate, and the like. Embodiments of the present disclosure are advantageous for at least the reason that the face fiber material can be recovered, while minimizing contamination from the backing material. In addition, embodiments of the present disclosure are advantageous because contamination can be minimized, which enables subsequent cleaning steps to achieve a higher purity in the recovered material.

In an embodiment, the method includes removing face fibers from a fibrous substrate. In general, the method includes providing a fibrous substrate that includes a plurality of face fibers and a backing structure. In an embodiment, the fibrous substrate is carpet. The face fibers can be removed from the fibrous substrate so that the face fibers and the backing structure can be separated and independently processed. The face fibers can be removed using a system such a band blade system, a splitting machine system, hoop knife, or combinations thereof. Once the face fibers are removed, the face fibers can be collected. The collected face fibers can be cleaned to remove contaminants via dry mechanical processes including, but not limiting to, opening, garneting, carding, granulating and/or washing (batch or continuous process). In an embodiment, the face fibers can be cleaned via a water based slurry for loosening impurities followed by centrifugal separation of fibers, surface impurities, and fluids. In an embodiment, the fibers may be sanitized during the wet cleaning process. In an embodiment, the collected face fibers can be carded and washed. Subsequently, the cleaned face fibers can be collected and/or bailed for recycling.

The face fibers can include face fibers made from one or more types of polymers. The polymers can be semi-crystalline polymers or amorphous polymers. The polymers can be a homopolymer, a copolymer, a terpolymer, polymer blends, or mixtures thereof. The polymers can include, but are not limited to, polyamides, polyesters (which can include bio-polymers), polyolefins (e.g., poly(ethylene), poly(propylene), and the like); poly(alkane terephthalates) (e.g., poly(ethylene terephthalate) (PET), 1,3 propanediol terephthalate (3GT), and the like); polycaprolactone (PCL); polyactic acid, precursors, derivatives, homopolymers, monomers, co-polymers, terpolymers, or combinations thereof.

In addition, the polymers can include, but are not limited to, acetal; polycarboxylate; polyphenylene oxides [PPO]; nylons [e.g., 4-6,6,6-6,6-3, 6-9,6-10, 6-12, 11, 12]; poly (L-lactide-co-glycolide); poly (alpha-hydroxy acid); poly-L-lactide (PLLA); poly-DL-lactide (PDLLA); poly-3-hydroxybutrate; polylactic acid; poly-1-lactic acid [PLLA]; polycaprolactone [PCL]; polyglycolic acid [PGA]; polyethersulfone [PES]; poly(alkyl-p-hydroxybenzoate)s; poly(benzimidazole)s; poly(benzoxazole)s; poly(benzthiazole)s; poly-(p-phenylene benzbisoxazole)s; poly-(p-phenylene benzbis-thiazole)s; polyacetals; polyamide imide; polyamides; polyamids; polyarylamides; polyarylate; polyarylene ether; polyarylsulfone [PAS]; polybenzimidazole; polybenzoates; polyethylene naphthalate [PEN]; polyphenols; polyphenylene ether; polyphenylene sulfide (PPS); polyphenylsulfone; polyphthalamide; polysulfides; polysulfones; their precursors, derivatives, copolymers, homopolymers, monomers, terpolymers, or combinations or compounds thereof.

The polyamides can be a homopolymer, copolymer, terpolymer, blends thereof, or mixtures of polymers. Embodiments of polyamide fibers include, but are not limited to, polyhexamethylene adipamide (nylon 6,6); polycaproamide (nylon 6); polyenanthamide (nylon 7); poly(10-aminodecanoic acid) (nylon 10); polydodecanolactam (nylon 12); polytetramethylene adipamide (nylon 4,6); polyhexamethylene sebacamide homopolymer (nylon 6,10); a polyamide of n-dodecanedioic acid and hexamethylenediamine homopolymer (nylon 6,12); and a polyamide of dodecamethylenediamine and n-dodecanedioic acid (nylon 12,12). In addition, the polyamide can be a copolymer polyamide (e.g., a polyamide polymer derived from two or more dissimilar monomers).

The backing structure can include one or more backing structures, adhesives, and other layers. In an embodiment, the backing structure can include a primary backing structure having a yarn tufted through the primary backing to form face fibers. The underside of the primary backing structure can include one or more layers of material (e.g., coating layer, a secondary backing, and the like) to cover the backstitches of the yarn. One or more other layers, coatings, and/or materials can be included in the backing structure. Reference to the backing structure refers to components of the fibrous structure (e.g., carpet) other than the face fibers. Once the face fibers are separate from the backing structure, the backing structure may include one or more structures.

FIG. 1 illustrates an embodiment of a flow chart for a method of removing face fibers from a fibrous substrate (10), in particular, a carpet. As mentioned above, the carpet can include face fibers and a backing structure. Initially, the carpet is provided (100). Next, the carpet is processed (110). In an embodiment, the carpet is processed (110) by properly aligning the carpets (111) so that the carpet can be cut (113) into appropriate cut-portions for the system. The cut-portions of the carpet can be about 1 to 10 feet by about 1 to 15 feet. Larger or smaller cut-portions can be used depending on the system. Next, the cut-portions can be cleaned (115) to remove debris such as dirt. In addition, the presence of metal objects can be detected and, if present, removed (117). Once the cut-portions are cleaned, the cut-portions of the carpet can be flattened (119) so that the cut-portions can be further processed.

Once the cut-portions are processed, the face fibers can be removed (120) form the carpet so that the face fibers and backing structure are separated. The face fibers can be removed from the carpet using a band blade system, a splitting machine system, hoop knife, or combinations thereof. In an embodiment, about 10 to 50% of the weight of the whole carpet can be removed as face fibers.

In an embodiment, the face fibers are removed using a splitting machine system. A splitting machine system operates by using nip rolls to force the carpet into a band blade to separate the face fibers from the backing structure.

Once the face fibers are removed from the carpet, the backing substrate can be collected (130) for recycling and/or disposal. In an embodiment, the backing substrate is bailed (135) for recycling and/or disposal. In an embodiment, the backing may be size reduced by chopping and/or shredding either before or after baling to facilitate recycling and/or disposal.

In an embodiment, the face fibers can be collected and baled (140) for recycling. In another embodiment, the face fibers can be cleaned (143). In an embodiment, the face fibers can be cleaned via washing (145) (e.g., washed in a washing machine using water and/or appropriate detergent and/or other washing chemicals including sterilization chemicals (See the examples for an embodiment of a method of washing)). In an embodiment, the face fibers can be cleaned via carding (147). In an embodiment, the face fibers can be carded and/or washed (145 and 147). After the face fibers are cleaned, the face fibers can be collected (149). In an embodiment, the collected, cleaned face fibers can be baled for recycling or accumulated to be used (e.g., use of the face fibers “as is”). In an embodiment, the collected fiber is densified or pelletized for recycling.

In an embodiment, one or more of the methods described herein can be implemented using a face fiber removing system 200 as described in FIG. 2. In an embodiment, a fibrous substrate (e.g., a carpet) is positioned and/or aligned on an air bearing table system (210). In an embodiment, the air bearing table system (210) can be replaced with or used in conjunction with laser projection of the cutting template and a low friction cutting table.

Once appropriately aligned, the carpet is directed to a rip saw system (220) to cut the carpet into cut-portions of the carpet. The rip saw cuts the carpet into appropriately sized cut-portions of the carpet that can be further processed. A conveyor system or other system can be used to direct the carpet to the rip saw system (220). In an embodiment, the rip saw system can be replaced with or used in conjunction with a rotary knife and crosscut saw. A conveyor system or other system can be used to direct the cut-portions to the following system.

The cut-portions of the carpet can be directed to a brush/vacuum system (230) or alternative cleaning system to remove debris such as dirt using appropriate beaters and/or vacuum system equipment. In addition, the presence of metal objects can be detected and removed in a metal detection/removal system (240), which includes a metal detector to detect the presence of one or more objects in the cut-portions of the carpet. A conveyor system or other system can be used to direct the cut-portions among the brush/vacuum system (230) and the metal detection/removal system (240).

Next, the cut-portions of the carpet are flattened so that they can be introduced to the face fiber/carpet backing separating system (260). The cut-portions of the carpet are flattened using a steamer box/spreader roll system (250). In short, the steamer box/spreader roll system (250) operates by providing heat to soften the backing material and spiral fluted rolls to tension the backing material. A mechanical belt or spiked apron conveyor system or other system can be used to direct the cut-portions to the following system.

Once the cut-portions of the carpet are flattened, the cut-portions are directed to the face fiber/carpet backing separating system (260). The face fiber/carpet backing separating system (260) operates to remove the face fibers from the backing structure of the carpet. As noted above, the face fibers can be removed from the carpet using a band blade system, a splitting machine system, hook knife, or combinations thereof. The face fibers can be segregated from the backing structure and directed to different systems of the face fiber removing system 200. A conveyor system or other system can be used to segregate and/or separate the face fibers and the backing structure.

In an embodiment, the backing structure is collected by the carpet backing processing system (270). As noted above, the backing structure can be collected and baled for recycling or disposal.

In an embodiment, the face fiber is collected using a face fiber baling system (280), which bales the face fiber for recycling or disposal.

In an embodiment, the face fiber is collected using the face fiber cleaning system (290). The face fibers are cleaned via carding and/or washing, as described above and in the Examples. The cleaned face fibers can be baled for recycling and/or disposal or accumulated to be used (e.g., use of the face fibers “as is”).

### Example Method for Washing Recycled Carpets

### Equipment

A) Balance—Mettler Model PE-3600, PM-2000, and PE1600 top loading (Capacity 1200 gm and 2000 gm, respectively), sensitivity +/−0.01 gm or equivalent.

B) Scouring Bags: Fiber—70 Denier Filament Polyester; Fabric—Warp Knit (Marquitte); Weight—2.3 Oz./yd²; Size—10″×16″; Construction—Double Thickness, Double Stitched; Closure Method—Drawstring.

C) Washer—Sears Kenmore Model 29851—Variable Volume or currently available ‘AATCC’ —approved equivalent model.

Reagents: Merpol HCS (Prepare 10% aqueous solution), Depuma (Antifoam), American Aniline Products, Inc., Sodium Carbonate—Purified Grade (10% Aqueous Solution), and Acetic Acid—Reagent Grade—(10% Aqueous Solution).

Procedure
1) Weigh 100 g sample of recycled carpet face fiber and place into scouring bag
2) Start washing machine (Using “Super Heavy Duty” wash cycle) to fill it ¾ full (64+/−4 litres) of hot water (63+/−2 degrees C.).
3) Add 320 ml “Merpol” HCS (10% solution), start washer for 30-60 seconds to mix the detergent in the water.
4) Draw a water sample from the washer to check pH with pH meter. Adjust pH between 6.5-7.5 range (if less than 6.5, add 10% solution of sodium carbonate, if greater than 7.5 add acetic acid).

5) Place the souring bag into the water and start the washer. The wash cycle should consist of the following times (for a grand total of 32 minutes): Fill (hot setting) (4 minutes); Scour (14 minutes); Drain (2 minutes); Spin—Extract (2 minutes); Warm Rinse Agitation—Fill (2 Minutes); Drain (2 minutes); and Spin (6 minutes)

6) Remove scouring bag from the washer. Remove fiber from the bag and let it air dry.

Example Procedure for Carding Sheared Carpet Face Fiber

a) Hold a carder in each hand.

b) Place the back of the carder in non-dominant hand against your leg to support the carder and to keep it from moving.

c) Place approximately 2-3 grams of fiber on the carder that is supported on the leg.

d) With an opposing motion, pull the carder in the dominant hand through the stationary carder.

e) Take care to catch any fibers that fall and place them back on the stationary carder.

f) Be aware of the teeth of the carder that can easily puncture skin.

g) This process will transfer small amounts of the fiber to the carder in the dominant hand.

h) Once all the material has been transferred, repeat this process (Steps c-e) until all the fibers are properly opened and carded.

i) Remove the fiber from carder and repeat Steps a through h until desired amount of fiber has been carded.

It should be noted that other procedures can be used.

Procedure for Ash Content Determination

a) Accurately weigh about 10 to 25 mg of a sample and place it into a preconditioned platinum crucible.

b) Moisten the sample with concentrated sulfuric acid (98%), where the amount of sulfuric acid is enough to cover the sample (usually 1 to 3 drops).

c) Using a hot plate heat the sample gently to about 350+/−50 degrees C. until the sample is charred. Slowly heat the sample to ensure no material is lost due to overheating.

d) Heat the residue to about 60° C.-900 degrees C. until all organic material has been burned off

e) Take the sample out and allow it to cool to room temperature in a dessicator with silica gel.

f) Weigh the residue.

g) Repeat steps d) through f) until the residue attains a constant weight.

h) Calculate the percent ash as follows: % Ash=(Final residue weight/Initial sample)×100.

### EXAMPLES

### Example 1

Samples 1A through 1C are sheared face fiber collected from several light colored nylon-66 post consumer carpets. The samples were tested for impurity level of inorganic substances in the face fiber by the Ash Analysis method described above. Percent (%) ash content in each fiber is given in Table 1.

### Example 2

Samples 2A through 2C are post-consumer carpet face fiber from the same batch as Samples 1A to 1C, but were carded using the procedure described above. These samples were also tested for ash content and the results are listed in Table 1.

### Example 3

Samples 3A through 3C are post-consumer carpet face fiber from the same batch as Samples 1A to 1C, but were washed using the procedure described above. These samples were also tested for ash content and the results are listed in Table 1.

### Example 4

Samples 4A through 4C are post-consumer carpet face fiber from the same batch as Samples 1A to 1C, but were carded using the procedure described above and were then washed as per above procedure. These samples were also tested for ash content and the results are listed in Table 1.

TABLE 1

| Sample # | Sample ID | % Ash |
|---|---|---|
| 1A | Carpet Tuft control 1 | 0.34 |
| 1B | Carpet Tuft control 1 Repeat | 0.26 |
| 1C | Carpet Tuft control 1 Repeat | <0.1 |
| 2A | Carded Carpet Tuft | 0.44 |
| 2B | Carded Carpet Tuft Repeat | 0.30 |
| 2C | Carded Carpet Tuft Repeat | 0.69 |
| 3A | Washed Carpet Tuft | <0.1 |
| 3B | Washed Carpet Tuft Repeat | <0.1 |
| 3C | Washed Carpet Tuft Repeat | <0.1 |
| 4A | Carded and Washed Carpet Tuft | <0.1 |
| 4B | Carded and Washed Carpet Tuft Repeat | <0.1 |
| 4C | Carded and Washed Carpet Tuft Repeat | <0.1 |

The ash content data in Table 1 shows that the inorganic impurity level in the post-consumer sheared face fiber is reduced significantly after washing or carding and washing. It is clear from these examples that these cleaning methods are effective in removing the surface contaminant from the sheared face fiber and results in a higher quality recycled material.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to “y” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim the following:

1. A method of removing face fibers from a fibrous substrate, comprising:
cutting a fibrous substrate into cut-portions of the fibrous substrate, wherein the fibrous substrate includes face fibers and a backing structure;
cleaning the cut-portions of the fibrous substrate to remove debris;
detecting for the presence of one or more of the metal objects in the cut portions of the fibrous substrate, and if a metal object is present, removing the metal object;
flattening the cut-portions of the fibrous substrate;
removing the face fibers from the fibrous substrate so that the face fibers and the backing structure are separated;
collecting the face fibers;
cleaning the face fibers; and
collecting the cleaned face fibers.

2. The method of claim 1, wherein cleaning the face fibers includes:
carding the face fibers.

3. The method of claim 1, wherein cleaning the face fibers includes:
opening the face fibers.

4. The method of claim 1 or 3, wherein cleaning the face fibers includes:
washing the face fibers.

5. The method of any one of claims 1 to 4, further comprising:
baling the face fibers.

6. The method of any one of claims 1 to 5, further comprising:
baling the backing structure.

7. The method of any one of claims 1 to 6, wherein removing the face fibers includes:
removing the face fibers from the fibrous substrate using a system selected from: a band blade system, a splitting machine system, a hook knife, and combinations thereof.

8. The method of any one of claims 1 to 7, wherein cutting a fibrous substrate into cut-portions of the fibrous substrate includes:
cutting the fibrous substrate using a rip saw.

9. The method of any one of claims 1 to 8, further comprising:
segregating the face fiber from the backing structure.

10. A method of removing face fibers from a fibrous substrate, comprising:
providing a fibrous substrate, wherein the fibrous substrate includes face fibers and a backing structure;
removing the face fibers from the fibrous substrate so that the face fibers and the backing structure are separated;
collecting the face fibers;
cleaning the face fibers; and
collecting the cleaned face fibers.

11. The method of claim 10, wherein removing the face fibers includes:
removing the face fibers from the fibrous substrate using a system selected from: a band blade system, a splitting machine system, a hook knife, and combinations thereof.

12. The method of claim 10 or 11, wherein cleaning the face fibers includes:
opening or carding the face fibers.

13. The method of claim 10 or 11, wherein cleaning the face fibers includes:
opening the face fibers.

14. The method of any one of claims 10 to 13, wherein cleaning the face fibers includes:
washing the face fibers.

15. The method of any one of claims 10 to 14, further comprising:
baling the face fibers.

16. The method any one of claims 10 to 15, further comprising:
baling the backing structure.
